(19) United States
(12) Patent Application Publication
(10) Pub. No.: US 2026/0268537 A1
(43) Pub. Date: Sep. 10, 2026

(54) INFORMATION PROCESSING METHOD, INFORMATION PROCESSING DEVICE, AND NON-TRANSITORY COMPUTER READABLE RECORDING MEDIUM

(71) Applicant: PANASONIC INTELLECTUAL PROPERTY MANAGEMENT CO., LTD., Osaka (JP)

(72) Inventors: Kazuko NISHIMURA, Kyoto (JP); Makoto FUJINO, Osaka (JP); Seikou ABE, Osaka (JP)

(73) Assignee: PANASONIC INTELLECTUAL PROPERTY MANAGEMENT CO., LTD., Osaka (JP)

(21) Appl. No.: 19/661,251

(22) Filed: Apr. 28, 2026

Related U.S. Application Data
(63) Continuation of application No. PCT/JP2024/038130, filed on Oct. 25, 2024.
(60) Provisional application No. 63/547,010, filed on Nov. 2, 2023.

(30) Foreign Application Priority Data
Jun. 17, 2024 (JP) 2024-097575

(51) Int. Cl. G06T 11/00

(52) U.S. Cl. CPC G06T 11/00; G06T 2200/24

(57) ABSTRACT

An information processing method includes: displaying a bird’s-eye view including a specified spot on a display of an information terminal, and displaying in the bird’s-eye view a plurality of photographing spot icons each indicating a photographing spot and being linked with an image captured at the photographing spot, wherein the displaying includes reducing the display quantity of photographing spot icons in a first predetermined region including no specified spot.

### FIELD OF INVENTION

The present disclosure relates to a technique for displaying photographing spot icons in a bird’s-eye view.

### BACKGROUND ART

Patent Literature 1 discloses a construction image capture instruction system including: receiving an operation of specifying a desired spot on design drawing data displayed on a display part; generating an image capture instruction of directing a capture of an image of a construction site at the specified spot; displaying an icon indicative of the image capture instruction on the design drawing data; and linking the icon with the image of the construction site captured in accordance with the image capture instruction.

However, Patent Literature 1 merely discloses a technique for linking an icon with an image captured at a specified spot. Therefore, the technique does not make it possible to reduce the volume of data to be stored by data decimation according to a desired rule.

Patent Literature 1: International Unexamined Patent Publication No. 2022/145021

### SUMMARY OF THE INVENTION

The present disclosure has been made in order to solve the problem described above, and an object thereof is to provide a technique for efficiently reducing data volume by efficiently removing a plurality of photographing spot icons each having a linked image.

An information processing method according to an aspect of the present disclosure is an information processing method by a computer, including: displaying a bird’s-eye view including a specified spot on a display of an information terminal; and displaying in the bird’s-eye view a plurality of photographing spot icons each indicating a photographing spot and being linked with an image captured at the photographing spot, wherein the displaying includes reducing the display quantity of photographing spot icons in a first predetermined region including no specified spot.

The present disclosure makes it possible to efficiently reduce data volume by efficiently removing a plurality of photographing spot icons each having a linked image.

### BRIEF DESCRIPTION OF THE DRAWINGS

FIG. 1 is a diagram showing a general configuration of an information processing system according to Embodiment 1.

FIG. 2 shows an exemplary design drawing according to Embodiment 1.

FIG. 3 is a flowchart showing a process of the information processing system according to Embodiment 1.

FIG. 4 is a flowchart showing a process of an information processing system according to Modification 1 of Embodiment 1.

FIG. 5 is a flowchart showing a process of an information processing system according to Modification 2 of Embodiment 1.

FIG. 6 is a flowchart showing a process of an information processing system according to Modification 3 of Embodiment 1.

FIG. 7 is a diagram showing a general configuration of an information processing system according to Embodiment 2.

FIG. 8 is a drawing showing an image where annotation information is displayed.

FIG. 9 is a flowchart showing a process of the information processing system according to Embodiment 2.

FIG. 10 is a flowchart showing a process of an information processing system according to Modification 1 of Embodiment 2.

FIG. 11 is a diagram showing a general configuration of an information processing system according to Embodiment 3.

FIG. 12 shows a design drawing resulting from a process of Embodiment 3.

FIG. 13 is a flowchart showing the process of the information processing system according to Embodiment 3.

### DETAILED DESCRIPTION

### Knowledge Underlying the Present Disclosure

There is ongoing progress in developing a user interface configured to display, on a two-dimensional design drawing reflecting a work site and the like, a plurality of photographing spot icons each indicating a photographing spot at which an image of the work site is actually captured, and to display, when one photographing spot icon is selected, an image captured at the photographing spot indicated by the one photographing spot icon. This enables a manager for the work site to grasp a situation in the work site without visiting the work site.

With the user interface, if all the images captured by a camera at a predetermined frame rate are stored, the data volume will become huge and the memory resource will be lessened. A work site has an important spot and a less important spot. Removal of certain photographing spot icons concerning spots around the less important spot will keep images linked with the certain photographing spot icons from being stored. Therefore, the volume of data to be stored can be efficiently reduced by storing many images linked with spots around the important spot to secure the amount of information of them while storing fewer images linked with spots around the less important spot.

The present disclosure has been made on the basis of such knowledge, and an object thereof is to provide a technique capable of efficiently reducing the data volume by efficiently removing a plurality of photographing spot icons each bearing a linked image.

(1) An information processing method according to an aspect of the present disclosure is an information processing method by a computer, including: displaying a bird’s-eye view including a specified spot on a display of an information terminal, and displaying in the bird’s-eye view a plurality of photographing spot icons each indicating a photographing spot and being linked with an image captured at the photographing spot, wherein the displaying includes reducing the display quantity of photographing spot icons in a first predetermined region including no specified spot.

In this configuration, the plurality of photographing spot icons are displayed in the bird’s eye view while reducing the display quantity of photographing spot icons in the first predetermined region including no specified spot. Therefore, many images linked with spots around the important spot, i.e., the specified spot, can be stored to secure the amount of information of them while storing fewer images linked with spots around the less important spot. Accordingly, the data volume can be efficiently reduced by efficiently removing photographing spot icons each bearing a linked image.

(2) In the information processing method disclosed in the above-mentioned (1), it may be appreciated that the specified spot is at a coordinate preset in the bird’s-eye view, and the reducing of the display quantity includes reducing the display quantity of photographing spot icons in the first predetermined region so as to be smaller than the display quantity of photographing spot icons in a second predetermined region including the specified spot.

In this configuration, the display quantity of photographing spot icons concerning spots around the unspecified spot is reduced so as to be smaller than the display quantity of photographing spot icons concerning spots around the specified spot. Therefore, the data volume can be efficiently reduced by priorly storing the images captured in an area that includes the specified spot and spots around it and is considered to be important by a user.

(3) In the information processing method disclosed in the above-mentioned (1) or (2), it may be appreciated that the specified spot is a photographing spot indicated by a photographing spot icon linked with annotation information.

In this configuration, a larger quantity of photographing spot icons concerning spots around the photographing spot linked with the annotation information can be displayed than the quantity of photographing spot icons concerning spots around the photographing spot linked with no annotation information. Consequently, the images captured at the photographing spots to which attention is called can be priorly stored.

(4) In the information processing method disclosed in the above-mentioned (1), it may be appreciated that each of the photographing spot icons has an area surrounding the photographing spot in the bird’s-eye view, the displaying includes extracting a photographing spot icon among the photographing spot icons in such a manner that their areas do not overlap one another, and displaying the extracted photographing spot icon, the specified spot is the photographing spot indicated by the extracted photographing spot icon, and the first predetermined region is the area of the other photographing spot icon than the extracted photographing spot icon.

In this configuration, the photographing spot icons are extracted in such a manner that their areas do not overlap one another. Therefore, the photographing spot icons can be efficiently thinned out.

(5) In the information processing method disclosed in the above-mentioned (2), it may be appreciated that the reducing of the display quantity includes keeping a photographing spot icon linked with annotation information in the first predetermined region among the photographing spot icons in the first predetermined region.

In this configuration, the photographing spot icon linked with the annotation information in the first predetermined region including no specified spot is kept therein. This can prevent the annotation information and the image linked with the annotation information from being removed.

(6) In the information processing method disclosed in any one of the above-mentioned (1) to (5), it may be appreciated that the display quantity of photographing spot icons in the first predetermined region is set to a value of keeping a resolution preset for the photographing spots.

This configuration can prevent an excessive lack of information on the first predetermined region due to an excessive removal of photographing spot icons from the region.

(7) In the information processing method disclosed in the above-mentioned (2) or (3), the display quantity of photographing spot icons in the second predetermined region may be appreciated to be set to a value that accords with a frame rate for the photographing.

In this configuration, photographing spot icons are in the second predetermined region in the quantity according with the frame rate. Consequently, detailed information on the region can be stored.

(8) In the information processing method disclosed in the above-mentioned (2) or (3), it may be appreciated that the bird’s-eye view includes a bird’s-eye view of a building including a column, a wall, or a material, and the display quantity of photographing spot icons in the second predetermined region is set to such a value that one photographic spot indicated by one photographing spot icon is at one side of the column, the wall, or the material, and another photographic spot indicated by another photographing spot icon is at another side of the column, the wall, or the material.

In this configuration, the display quantity in the second predetermined region can be set in such a manner that a space having not been photographed due to blocking of a column, a wall, or a material at the one photographing spot can be displayed by a photography at the another photographing spot.

(9) In the information processing method disclosed in the above-mentioned (2) or (3), it may be appreciated that each of the photographing spot icons is linked with a photographing time of the linked image, and the reducing of the display quantity includes displaying photographing spot icons in the first predetermined region in such a display quantity that a time interval between a photographing time linked with a photographing spot icon and a photographing time linked with its neighboring photographing spot icon is a first time interval; and displaying photographing spot icons in the second predetermined region in such a display quantity that a time interval between a photographing time linked with a photographing spot icon and a photographing time linked with its neighboring photographing spot icon is a second time interval shorter than the first time interval.

This configuration can reduce the display quantity of photographing spot icons in the first predetermined region so as to be smaller than the display quantity of photographing spot icons in the second predetermined region by using the photographing time.

(10) In the information processing method disclosed in any one of the above-mentioned (1) to (5), it may be appreciated that the reducing of the display quantity includes displaying photographing spot icons in the first predetermined region in such a manner that a distance between neighboring photographing spot icons becomes a first distance, and displaying photographing spot icons in the second predetermined region in such a manner that a distance between neighboring photographing spot icons becomes a second distance shorter than the first distance.

This configuration can reduce the display quantity of photographing spot icons in the first predetermined region so as to be smaller than the display quantity of photographing spot icons in the second predetermined region by using the distance.

(11) An information processing apparatus according to another aspect of the present disclosure is an information processing apparatus including a processor that causes displaying a bird’s-eye view including a specified spot on a display of an information terminal, and displaying in the bird’s-eye view a plurality of photographing spot icons each indicating a photographing spot and being linked with an image captured at the photographing spot, wherein the displaying includes reducing the display quantity of photographing spot icons in a first predetermined region including no specified spot.

This configuration makes it possible to provide an information processing apparatus that can efficiently reduce the data volume.

(12) An information processing program according to still another aspect of the present disclosure causes a computer to display a bird’s-eye view including a specified spot on a display of an information terminal; and display in the bird’s-eye view a plurality of photographing spot icons each indicating a photographing spot and being linked with an image captured at the photographing spot, wherein the displaying includes reducing the display quantity of photographing spot icons in a first predetermined region including no specified spot.

This configuration makes it possible to provide an information processing program that can efficiently reduce the data volume.

The present disclosure may be implemented as an information processing system which operates in accordance with the information processing program. It is needless to say that the computer program may be distributed via a computer-readable non-transitory recording medium such as a CD-ROM or a communication network such as Internet.

Each of embodiments described below shows a specific example of the present disclosure. Numerical values, shapes, elements, steps, order of steps, and the like that are indicated in the following embodiments are merely examples, and are not intended to delimit the present disclosure. Among the elements in the following embodiments, elements not recited in the independent claims representing the broadest concepts are described as optional elements. In all the embodiments, the respective contents may also be combined.

Embodiment 1

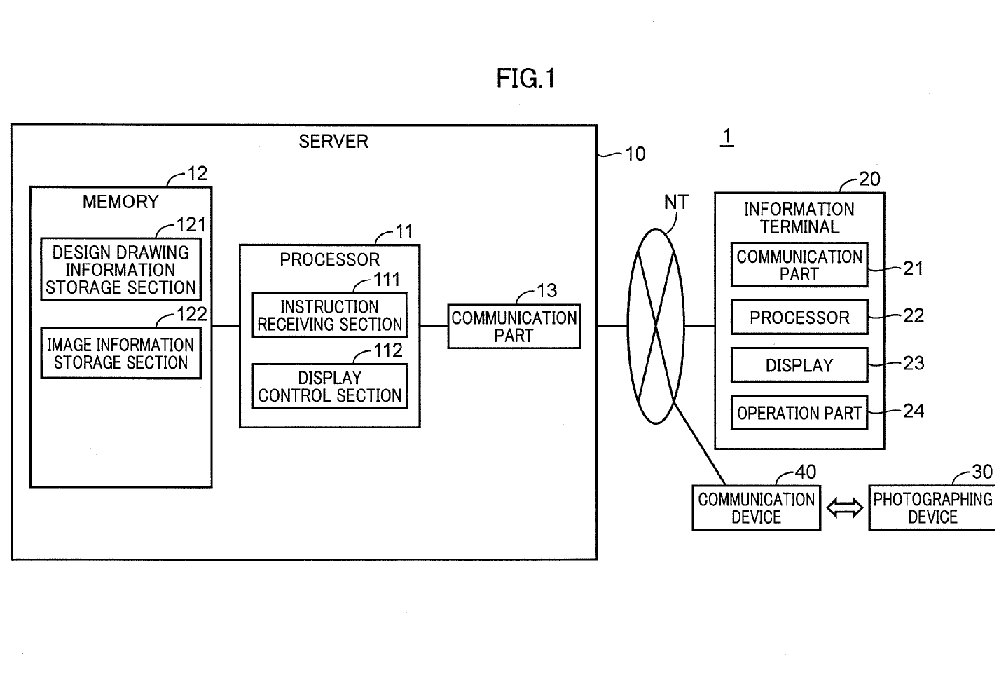

FIG. 1 is a diagram showing a general configuration of an information processing system 1 according to Embodiment 1. The information processing system 1 causes the display quantity of photographing spot icons in a predetermined region including a specified spot to be larger than the display quantity of photographing spot icons in an outside region that is out of the predetermined region. The information processing system 1 includes a server 10, an information terminal 20, a photographing device 30, and a communication device 40. The server (an example of an information processing apparatus and a computer) 10, the information terminal 20, and the communication device 40 are mutually communicably connected via a network NT. An example of the network is the Internet. For example, the server 10 is a cloud server having one or a plurality of computers. However, this is merely an example. The server 10 may be an edge server or may be implemented in the information terminal 20. In a configuration where a server 10 is provided in an information terminal 20, the information terminal 20 may be configured by an information processing apparatus.

The information terminal 20 is carried by a user. For example, the user is a manager for a certain space to be photographed by the photographing device 30. For example, the certain space is a construction site. However, this is merely an example. The certain space may be a work site, a factory, a store, or an office. For example, the information terminal 20 may be configured in a portable computer such as a smartphone and a tablet computer, or a stationary computer. The information terminal 20 is adapted to display an image on a display under a control of the server 10. FIG. 1 shows only one information terminal 20 as an example. However, a plurality of information terminals may be connected to the server 10 via a network. The information terminal 20 includes a communication part 21, a processor 22, a display 23, and an operation part 24.

The communication part 21 serves as a communication interface for connecting the information terminal 20 to the network NT. The communication part 21 sends to the server 10 instruction signals carrying various instructions received from the user by the way of the operation part 24. The communication part 21 receives from the server 10 display data to display various display images.

For example, the processor 22 is a central processing unit, and displays on the display 23 a display image on the basis of the display data received by the communication part 21.

The display 23 is configured by a display device such as a liquid crystal display, an organic EL display, and the like, and displays various display images under a control of the processor 22.

The operation part 24 is configured by a keyboard, a touch panel, or a mouse, and receives various instructions inputted by the user.

For example, the communication device 40 is configured by a portable information terminal such as a smartphone and a tablet computer, and connects the photographing device 30 to the network NT. The communication device 40 and the photographing device 30 are connected via a short-range wireless communication path such as Bluetooth (registered trademark). The communication device 40 is carried by a photographing person.

For example, the photographing device 30 includes an omnidirectional camera, and captures an image at a predetermined frame rate. The omnidirectional camera, which is called as a 360-degree camera, is a camera capable of capturing an omnidirectional image covering 360 degrees. For example, the photographing device 30 is a portable photographing device carried by the photographing person. For example, the photographing person is an operator or a site foreman in a construction site. The photographing device 30 may be an ordinary camera.

The photographing person moves in a certain space while photographing the construction site by the photographing device 30. When the photographing is completed, the photographing device 30 is allowed to send photographing information including a series of captured images to the server 10 via the communication device 40.

The photographing information includes captured images, a photographing start spot, a photographing end spot, and a design drawing ID corresponding to the certain space. The design drawing ID is an identifier of identifying a design drawing of the certain space.

At the photographing start spot, the photographing person sets a photographing direction of the photographing device 30 to north and presses a photograph button on the photographing device 30 to thereby start photographing. When arriving at the photographing end spot, the photographing person presses the photograph button again to thereby end the photographing.

The photographing start spot and the photographing end spot are determined by the photographing person inputting an instruction of specifying their respective positions in a design drawing image showing the certain space on the display of the communication device 40. Two-dimensional coordinate axes are defined over the design drawing image. Therefore, the photographing start spot and the photographing end spot are defined by two-dimensional coordinate values. The photographing start spot and the photographing end spot are used in order that the server 10 determines a position of each photographing spot and a photographing direction of each image.

A specified spot is linked with the design drawing. For example, the specified spot is set by the photographing person inputting an instruction of specifying its position in the design drawing showing the certain space on the display of the communication device 40. However, this is merely an example. The specified spot may be set by a user seeing the design drawing through an input of an instruction of specifying its position in the design drawing displayed on the display of the information terminal 20.

The server 10 includes a processor 11, a memory 12, and a communication part 13. For example, the processor 11 includes a central processing unit (CPU). The processor 11 includes an instruction receiving section 111 and a display control section 112. The instruction receiving section 111 and the display control section 112 may be accomplished by an execution of an information processing program by the processor 11, or may be accomplished by a dedicated hardware circuit such as ASIC.

The instruction receiving section 111 receives the instruction inputted by the user to the information terminal 20. Specifically, when the communication part 13 receives an instruction signal indicative of the instruction sent from the information terminal 20, the instruction receiving section 111 detects the input of the instruction by the user. The instruction includes a display instruction of displaying a design drawing on the display 23 of the information terminal 20 and a selection instruction of selecting one photographing spot icon among a plurality of photographing spot icons shown on the design drawing.

The display control section 112 displays the design drawing including the specified spot on the display 23. When the instruction receiving section 111 receives the display instruction, the display control section 112 displays the design drawing on the display of the information terminal 20. The design drawing is an example of the bird’s-eye view. The display instruction includes a design drawing ID. The display control section 112 may read a design drawing identified by the design drawing ID from a design drawing information storage section 121 and display the design drawing on the display 23.

The display control section 112 shows a plurality of photographing spot icons on the design drawing displayed on the display 23. Each photographing spot icon indicates a photographing spot and is linked with an image captured at the photographing spot.

The display control section 112 reduces the display quantity of photographing spot icons in the outside region so as to be smaller than the display quantity of photographing spot icons in the predetermined region. The predetermined region includes the specified spot. The predetermined region is an example of a second predetermined region including the specified spot. The outside region is an example of a first predetermined region. The predetermined region is a square-shaped region having a center at coordinates indicative of the specified spot and sides each denoted by α. However, this is merely an example. The predetermined region may be a circular region having a certain radius and a center at the specified spot.

The display quantity of photographing spot icons in the outside region may be set to a value of keeping a resolution preset for the photographing spots. The resolution for the photographing spots means a resolution set on the basis of the display quantity of photographing spot icons necessary for the manager to grasp a situation in the outside region on the design drawing.

The display quantity of photographing spot icons in the predetermined region may be set to a value that accords with a frame rate of the photographing device 30. Setting the display quantity of photographing spot icons to a value that accords with a frame rate for the photographing means displaying the photographing spot icons on every frame of the photographing device 30.

The design drawing is a bird’s-eye view of a building including a column, a wall, or a material. The display quantity of photographing spot icons in the predetermined region may be set to such a value that one photographic spot indicated by one photographing spot icon is at one side of the column, the wall, or the material, and another photographic spot indicated by another photographing spot icon is at another side of the column, the wall, or the material. For example, the another side of the column, the wall, or the material includes a rear side and a lateral side of the column, the wall, or the material. The design drawing is a drawing showing a design of a construction site, and may be a plan view, a blueprint, a map, or a perspective view of the construction site. The bird’s-eye view is also called as an overlooking view, and may be either an overlooking view or a view from a high place.

The display control section 112 may display photographing spot icons in the outside region in such a display quantity that a time interval between a photographing time linked with a photographing spot icon and a photographing time linked with its neighboring photographing spot icon is a first time interval. The first time interval may be a time interval determined in advance on the basis of a value of keeping the resolution for the photographing spots.

The display control section 112 may display photographing spot icons in the predetermined region in such a display quantity that a time interval between a photographing time linked with a photographing spot icon and a photographing time linked with its neighboring photographing spot icon is a second time interval shorter than the first time interval. It may be appreciated to adopt as the second time interval a time interval determined in advance on the basis of the value that accords with a frame rate of the photographing device 30. It may be appreciated to adopt as the second time interval such a time interval that one photographic spot indicated by one photographing spot icon is at one side of the column, the wall, or the material, and another photographic spot indicated by another photographing spot icon is at another side of the column, the wall, or the material.

The memory 12 is a non-volatile rewritable storage device such as a hard disk drive and a solid-state drive. The memory 12 includes the design drawing information storage section 121 and an image information storage section 122. The design drawing information storage section 121 stores design drawing information. The design drawing information is an image showing a design drawing of the certain space. The design drawing information is linked with a design drawing ID of identifying the design drawing.

The image information storage section 122 stores image information including the photographing information sent from the photographing device 30. The image information includes a plurality of images, a photographing start spot, a photographing end spot, and a design drawing ID that are included in the photographing information sent from the photographing device 30, and in addition, meta-information of each of the images. The image information is generated each time the photographing information is sent. The meta-information includes a photographing ID, a photographing period ID, a photographing time, a photographing direction, and a photographing spot.

The photographing ID is an identifier of a photographing spot. The photographing period ID is an identifier of a photographing period. The photographing period indicates a period from a start to an end of a photographing by the photographing person. The photographing time indicates a date and time at which an image is captured. The photographing direction is a direction in which each image is captured by the photographing device 30. The photographing spot is a position (two-dimensional coordinate values) indicating a spot at which an image is captured.

The photographing ID is an identifier of a photographing spot. The photographing period ID is an identifier of a photographing period. The design drawing ID is an identifier of a design drawing of the certain space corresponding to the image.

The communication part 13 is a communication interface for connecting the server 10 to the network.

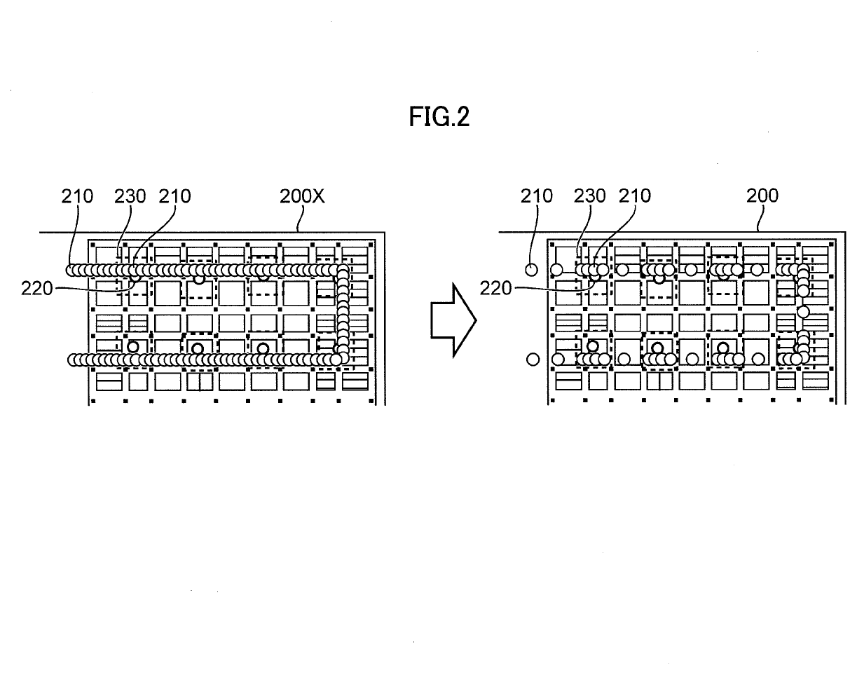

FIG. 2 shows an exemplary design drawing 200 according to Embodiment 1. The design drawing 200 is displayed on the display 23 under the control by the display control section 112. The left drawing in FIG. 2 shows a design drawing 200X not resulting from the process according to this embodiment. The right drawing in FIG. 2 shows an exemplary design drawing 200 resulting from the process according to this embodiment.

Since the design drawing 200X has not been subjected to the process according to this embodiment, a plurality of photographing spot icons 210 are displayed at a fixed interval.

In the design drawing 200, a plurality of specified spots 220 are set in the design drawing. The display control section 112 divides the design drawing into predetermined regions 230 including specified spots 220 and outside regions that are outside the predetermined regions 230. The display control section 112 causes the display quantity of photographing spot icons 210 in the predetermined region 230 to be larger than the display quantity of photographing spot icons 210 in the outside region.

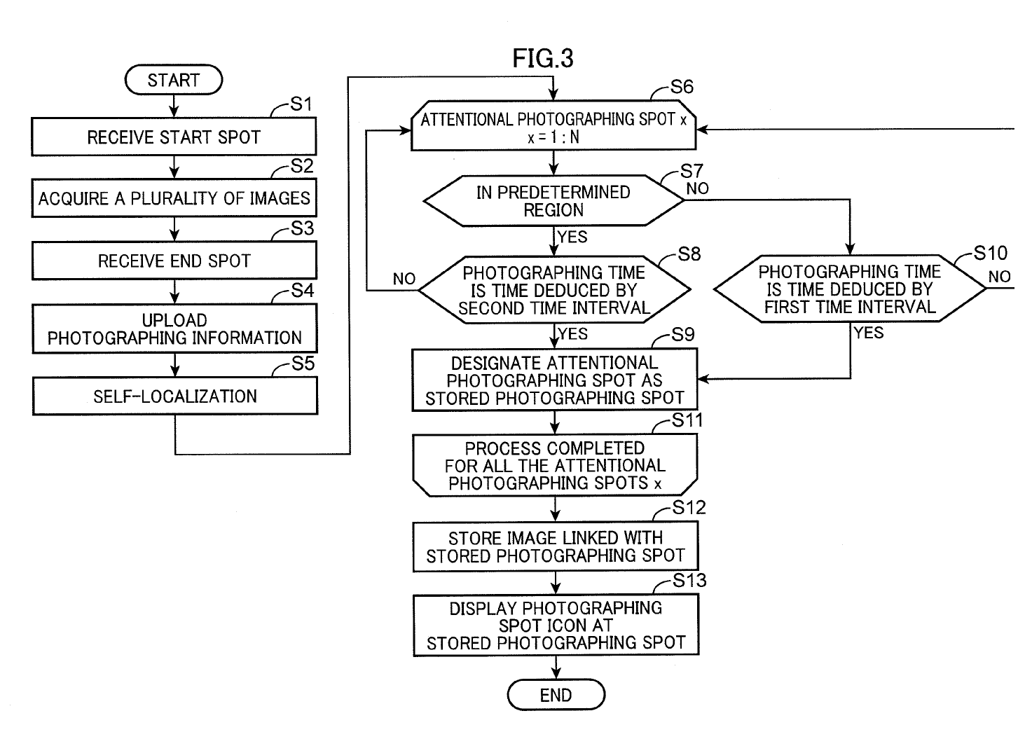

FIG. 3 is a flowchart showing a process of the information processing system 1 according to Embodiment 1.

In Step S1, an operation part of the communication device 40 receives an operation of inputting a photographing start spot (hereinafter, start spot). For example, the photographing person inputs an operation of specifying the start spot in the design drawing image displayed on the display of the communication device 40. The photographing person may either specify the start spot by tapping on the design drawing image or specify coordinate values of the start spot.

Next, in Step S2, the photographing device 30 starts photographing and acquires a plurality of images at a plurality of photographing spots. In a site, the photographing person sets a photographing direction of the photographing device 30 to north and inputs a photographing start instruction to the photographing device 30 to thereby cause a start of a photographing action in the certain space.

Next, in Step S3, the operation part of the communication device 40 receives an operation of inputting a photographing end spot (hereinafter, end spot). For example, the photographing person inputs an operation of specifying the end spot to the design drawing image displayed on the display of the communication device 40. The photographing person may either specify the end spot by tapping on the design drawing image or specify the photographing end spot by inputting coordinate values of the end spot.

Next, in Step S4, the communication device 40 acquires from the photographing device 30 photographing information including the images captured by the photographing device 30 during the photographing period, and uploads the acquired photographing information to the server 10.

Next, in Step S5, the display control section 112 calculates, using self-localization, a photographing spot of each of the images included in the photographing information acquired in Step S4. As the self-localization, VSLAM (Visual simultaneous localization and mapping) may be adopted.

For example, the display control section 112 detects, by way of image processing, a feature point of each of the images included in the photographing information. The feature point is a characteristic point of an object included in the image, such as a contour or the like. The display control section 112 executes self-localization using at least two images among the images having the feature to each of images to thereby calculate relative coordinate values of a photographing spot, i.e., self-position, of each image. The display control section 112 adjusts orientations at the respective photographing spots of the images to agree with one another on the basis that the photographing device 30 is set to north at the start of a photographing action. The display control section 112 calculates absolute coordinate values of the respective photographing spots of the images from the relative coordinate values of the respective photographing spots of the images with reference to coordinate values of the start spot and the end spot which are included in the photographing information, and designates the calculated absolute coordinate values as the coordinate values of the respective photographing spots of the images.

Next, in Step S6, the display control section 112 designates an attentional photographing spot x among the photographing spots calculated in Step S5, and starts the processing on the designated attentional photographing spot x. Hereinafter, the description is made on a case where there are N (N being an integer of 2 or greater) photographing spots. The display control section 112 designates attentional photographing spots according to an order of photographing times. x is an index indicating each of the photographing spots, wherein x = 1 to N.

Next, in Step S7, the display control section 112 determines whether the attentional photographing spot x is in the predetermined region 230. When the attentional photographing spot x is in the predetermined region 230 (YES in Step S7), the flow proceeds to Step S8. On the other hand, when the attentional photographing spot x is not in the predetermined region 230 (NO in Step S7), the flow proceeds to Step S10. The display control section 112 determines that the attentional photographing spot x is in the predetermined region 230 when coordinates of the attentional photographing spot x are in a coordinate region defining the predetermined region 230.

Next, in Step S8, the display control section 112 determines whether a photographing time linked with the attentional photographing spot x is a time deduced by a second time interval. When the photographing time is the time deduced by the second time interval (YES in Step S8), the flow proceeds to Step S9. When the photographing time is not the time deduced by the second time interval (NO in Step S8), the flow returns to Step S6.

The display control section 112 determines that a photographing time linked with the first attentional photographing spot x (=1) is the time deduced by the second time interval. For the second and succeeding attentional photographing spots x, the display control section 112 calculates a time difference between a photographing time linked with the attentional photographing spot x and a photographing time linked with the immediately preceding stored photographing spot, and determines that the photographing time linked with the attentional photographing spot x is the time deduced by the second time interval when the time difference is the second time interval.

Next, in Step S9, the display control section 112 designates the attentional photographing spot x as a stored photographing spot.

In Step S10, the display control section 112 determines whether the photographing time linked with the attentional photographing spot x is a time deduced by a first time interval. When the photographing time is the time deduced by the first time interval (YES in Step S10), the flow proceeds to Step S9. When the photographing time is not the time deduced by the first time interval (> second time interval) (NO in Step S10), the flow returns to Step S6.

The display control section 112 determines that the photographing time linked with the first attentional photographing spot x (=1) is the time deduced by the first time interval. For the second and succeeding attentional photographing spots x, the display control section 112 calculates a time difference between a photographing time linked with the attentional photographing spot x and a photographing time linked with the immediately preceding stored photographing spot, and determines that the photographing time linked with the attentional photographing spot x is the time deduced by the first time interval when the time difference is the first time interval.

Next, in Step S11, the display control section 112 determines whether the process is completed for all the attentional photographing spots x. When the process is not completed for all the attentional photographing spots x, the flow returns to Step S6, and a subsequent attentional photographing spot x is designated. On the other hand, when the process is completed for all the attentional photographing spots x, i.e., when the process for the attentional photographing spots x (= N) is completed, the flow proceeds to Step S12.

Next, in Step S12, the display control section 112 stores an image linked with the stored photographing spot in the image information storage section 122. Specifically, the display control section 112 adds meta-information to the image linked with the stored photographing spot and then stores the image added with the meta-information in the image information storage section 122.

Next, in Step S13, the display control section 112 displays a photographing spot icon 210 at the stored photographing spot in the design drawing 200. Accordingly, as shown in FIG. 2, the display 23 displays the design drawing 200 having a larger display quantity of photographing spot icons 210 in the predetermined region 230 than a display quantity of photographing spot icons 210 in the outside region.

As described above, in Embodiment 1, the display quantity of photographing spot icons in the outside region is reduced to be smaller than the display quantity of photographing spot icons in the predetermined region 230. Therefore, the data volume can be efficiently reduced by priorly storing the images captured in an area that includes the specified spot 220 and spots around it and is considered to be important by a user.

Modification 1 of Embodiment 1

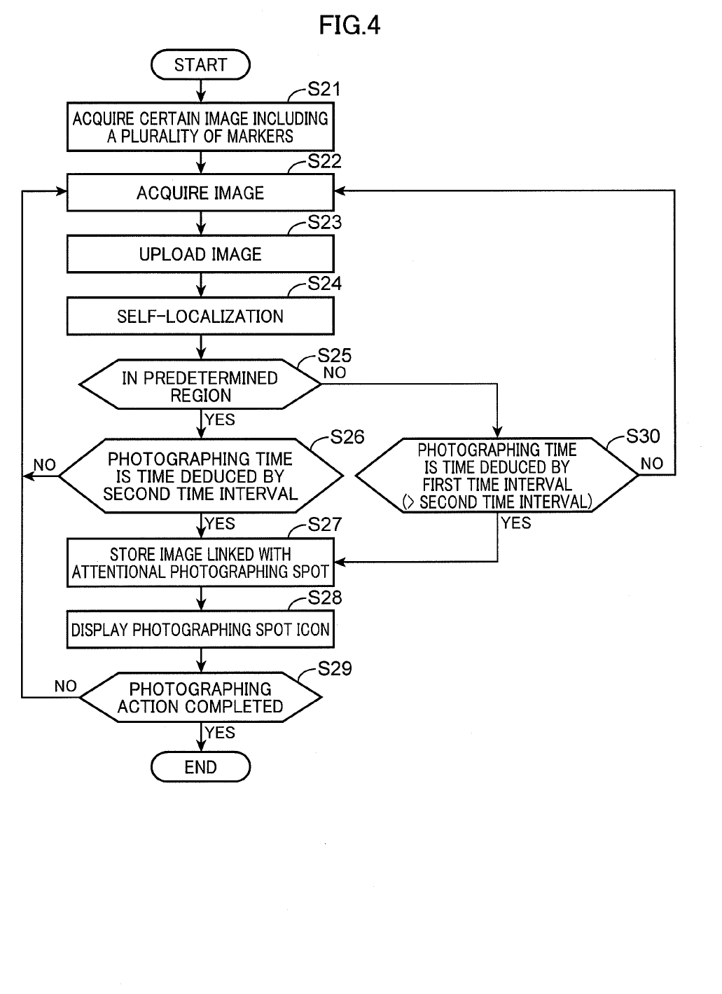

In this Modification, a photographing spot icon 210 is displayed in real time during a photographing action. FIG. 4 is a flowchart showing a process of an information processing system 1 according to Modification 1 of Embodiment 1. This flowchart is started by an input of a photographing start instruction to a photographing device 30 by the photographing person in the site.

In Step S21, the photographing device 30 acquires a certain image including a plurality of markers. For example, the markers are artificial markers arranged at predetermined positions in the site. The markers have certain shape and pattern. A QR code (registered trademark), an AR marker, or others may be used as the marker. Each of the markers is linked with an ID. The ID allows a display control section 112 to find, on a design drawing 200, coordinates of a position at which the marker is arranged. A communication device 40 uploads the certain image acquired in Step S21 to the server 10.

Next, in Step S22, the photographing device 30 acquires an image.

Next, in Step S23, the communication device 40 acquires from the photographing device 30 the image acquired in Step S22, and uploads the acquired image to the server 10.

Next, in Step S24, the display control section 112 calculates, using the self-localization, a photographing spot of the latest image acquired in Step S23. The photographing spot calculated in this step is designated as an attentional photographing spot.

Specifically, the display control section 112 detects a feature point from each of the latest image and a past image, and obtains relative coordinate values of the latest photographing spot on the basis of a positional relationship between the feature point in the past image and the feature point in the latest image. The display control section 112 adjusts an orientation at the photographing spot of the latest image on the basis that the photographing device 30 is set to north at the start spot. The display control section 112 calculates absolute coordinate values of the photographing spot from the relative coordinate values of the photographing spot of the latest image by using coordinate values of a plurality of marker spots.

Next, in Step S25, the display control section 112 determines whether the attentional photographing spot is in the predetermined region 230. Details of this processing are identical to those in Step S7 in FIG. 3. In the case of No in Step S25, the flow proceeds to Step S30. In the case of YES in Step S25, the flow proceeds to Step S26.

Next, in Step S26, it is determined whether a photographing time linked with the attentional photographing spot is a time deduced by the second time interval. Details of this processing are identical to those in Step S8 in FIG. 3. In the case of YES in Step S26, the flow proceeds to Step S27. In the case of NO in Step S26, the flow returns to Step S22. In this case, a subsequently acquired image is subjected to the processing of Step S23 onwards.

Next, in Step S30, it is determined whether the photographing time linked with the attentional photographing spot is a time deduced by the first time interval. Details of this processing are identical to those in Step S10 in FIG. 3. In the case of YES in Step S30, the flow proceeds to Step S27. In the case of NO in Step S30, the flow returns to Step S22. In this case, a subsequently acquired image is subjected to the processing of Step S23 onwards.

Next, in Step S27, an image linked with the attentional photographing spot is stored in the image information storage section 122. Specifically, the display control section 112 adds meta-information to the image linked with the stored photographing spot and then stores the image added with the meta-information in the image information storage section 122.

Next, in Step S28, the display control section 112 displays a photographing spot icon 210 at the attentional photographing spot in the design drawing 200. In this case, the photographing spot icon 210 is displayed on the design drawing 200 displayed on a display of the communication device 40. In a case where the design drawing 200 is displayed on the display of the information terminal 20, the photographing spot icon 210 may be displayed on this design drawing 200.

Next, in Step S29, the display control section 112 determines whether a photographing action is completed. The display control section 112 determines that the photographing action is completed when the photographing device 30 is inputted with a photographing end instruction. When the photographing action is not completed (NO in Step S29), the flow returns to Step S22. In this case, a subsequently acquired image is subjected to the processing of Step S23 onwards. On the other hand, the process ends when the photographing action is completed (YES in Step S29).

As described above, Modification 1 of Embodiment 1 makes it possible to display the photographing spot icon 210 on the design drawing 200 in real time during the photographing action.

Modification 2 of Embodiment 1

In this Modification, the display control section 112 displays photographing spot icons in an outside region outside a predetermined region 230 in such a manner that a distance between neighboring photographing spot icons becomes a first distance, and displays photographing spot icons in the predetermined region 230 in such a manner that a distance between neighboring photographing spot icons becomes a second distance shorter than the first distance.

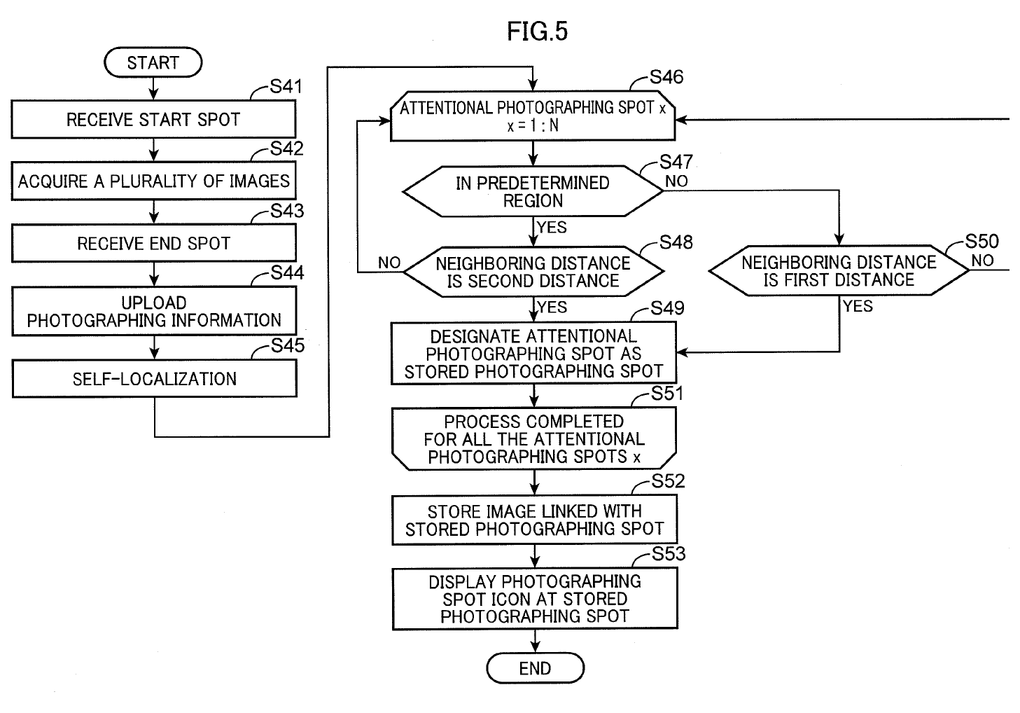

FIG. 5 is a flowchart showing a process of an information processing system 1 according to Modification 2 of Embodiment 1.

Processing in Steps S41, S42, S43, S44, S45, S46, S47, S49, S51, S52, and S53 is identical to those in Steps S1, S2, S3, S4, S5, S6, S7, S9, S11, S12, and S13 in FIG. 3.

In Step S48, the display control section 112 determines whether a neighboring distance from an attentional photographing spot x is a second distance. When the neighboring distance is the second distance (YES in Step S48), the flow proceeds to Step S49. When the neighboring distance is not the second distance (NO in Step S48), the flow returns to Step S46. The neighboring distance is a distance between the attentional photographing spot x and the immediately preceding stored photographing spot.

In Step S50, the display control section 112 determines whether the neighboring distance from the attentional photographing spot x is a first distance (> second distance). When the neighboring distance is the first distance (YES in Step S50), the flow proceeds to Step S49. When the neighboring distance is not the first distance (NO in Step S50), the flow returns to Step S46.

As described above, the information processing system 1 according to Modification 2 of Embodiment 1 makes it possible to reduce the display quantity of photographing spot icons 210 in the outside region outside the predetermined region 230 to be smaller than the display quantity of photographing spot icons 210 in the predetermined region 230 on the basis of a distance.

Modification 3 of Embodiment 1

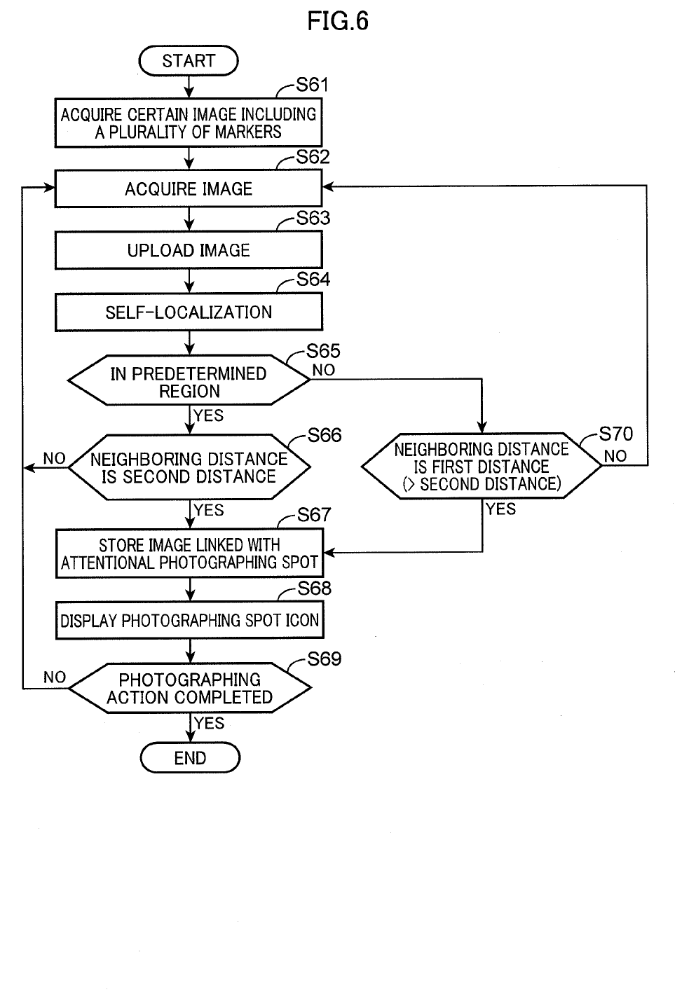

This is a combination of Modification 1 and Modification 2 of Embodiment 1. FIG. 6 is a flowchart showing a process of an information processing system 1 according to Modification 3 of Embodiment 1.

Processing in Steps S61, S62, S63, S64, S65, S67, S68, and S69 is identical to those in Steps S21, S22, S23, S24, S25, S27, S28, and S29 in FIG. 4.

In Step S66, a display control section 112 determines whether a neighboring distance from an attentional photographing spot is a second distance. When the neighboring distance is the second distance (YES in Step S66), the flow proceeds to Step S67. When the neighboring distance is not the second distance (NO in Step S66), the flow returns to Step S62.

In Step S70, the display control section 112 determines whether the neighboring distance from the attentional photographing spot is a first distance (> second distance). When the neighboring distance is the first distance (YES in Step S70), the flow proceeds to Step S67. When the neighboring distance is not the first distance (NO in Step S70), the flow returns to Step S62.

As described above, Modification 3 of Embodiment 1 makes it possible to determine a display quantity of photographing spot icons 210 on the basis of the neighboring distance in the aspect of displaying the photographing spot icons 210 in real time during the photographing action.

Embodiment 2

In Embodiment 2, a photographing spot indicated by a photographing spot icon 210 linked with annotation information is a specified spot. In Embodiment 2, the same elements as those of Embodiment 1 will be allotted with the same reference numerals, and the description thereof will be omitted.

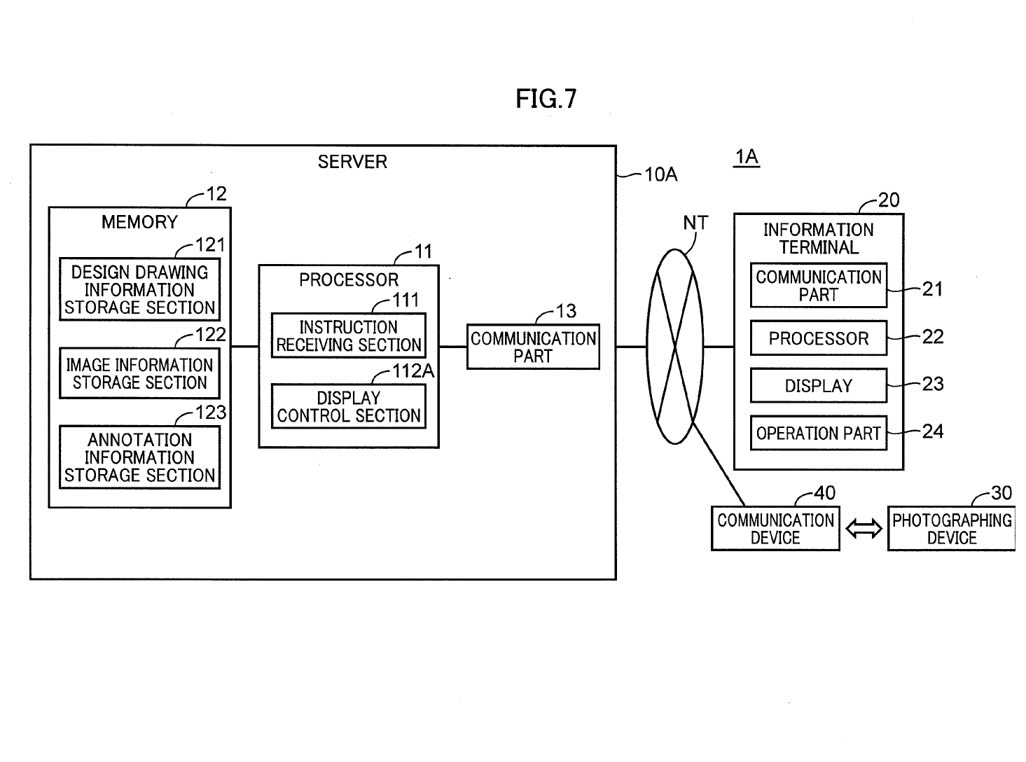

FIG. 7 is a diagram showing a general configuration of an information processing system 1A according to Embodiment 2. The information processing system 1A differs from the information processing system 1 in that the memory 12 additionally includes an annotation information storage section 123 and the processor 11 includes a display control section 112A.

The annotation information storage section 123 stores annotation information. The annotation information includes a comment added to an image and an annotated district. The comment is a written message about an item noticed by a user who sees an image displayed on a display 23. The comment is inputted by use of an information terminal 20 or a communication device 40. This enables the user to call for another user’s attention.

The annotated district is an area defined over an image by the user, and represents an annotation object to which the comment refers. The annotated district is defined by use of an operation part 24. For example, a component of a building is an annotation object in a case of a construction site. For example, when a user intends to add a comment to a door, an annotated district is defined by enclosing the door by a frame, and a comment is inputted in association with the annotated district. The annotation information is linked with a photographing ID. This specifies what image the annotation information refers to.

In Embodiment 2, the display control section 112A designates a photographing spot indicated by a photographing spot icon 210 linked with annotation information 330 as a specified spot. Therefore, a predetermined region 230 shows a region which includes the photographing spot indicated by the photographing spot icon 210 linked with the annotation information 330.

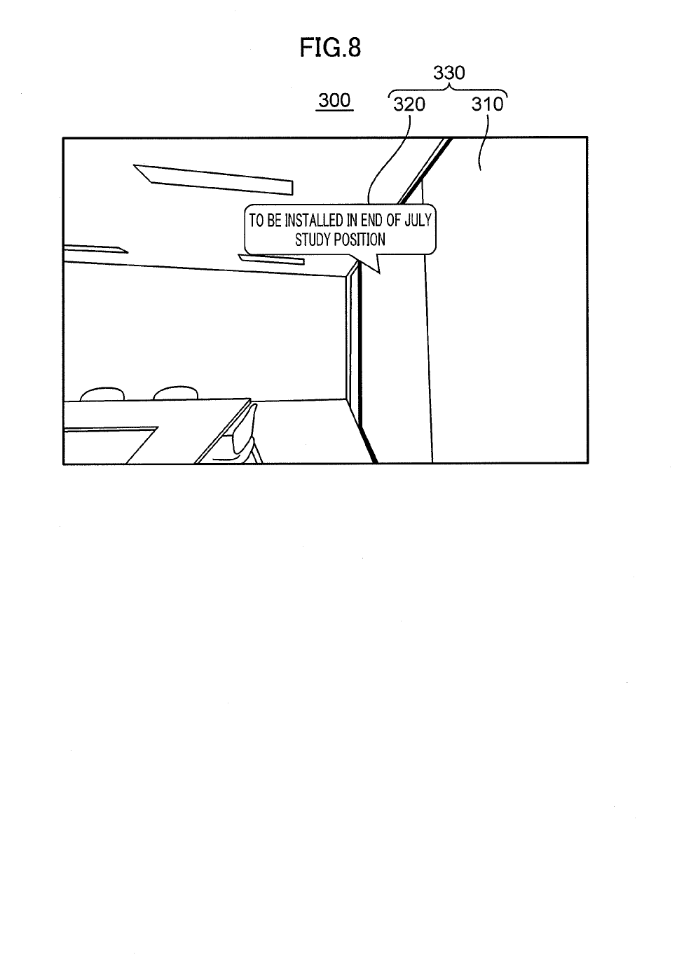

FIG. 8 is a drawing showing an image 300 where the annotation information 330 is displayed. The image 300 is an image captured by a photographing device 30. For example, the annotation information 330 is inputted in advance by a photographing person. After completing a photographing action, the photographing person causes a display of the communication device 40 to display an image 300 of a concerned photographing spot in a site. The photographing person inputs the annotation information 330 on the displayed image 300 by use of an operation part of the communication device 40. The annotation information 330 that is inputted to the communication device 40 and is linked with a photographing ID of the image 300 is sent from the communication device 40 to a server 10. The server 10 stores the annotation information 330 sent from the communication device 40 in the annotation information storage section 123.

The annotation information 330 may be inputted in advance by the user by use of the information terminal 20. For example, the user inputs a selection instruction of a certain photographing spot icon 210 among a plurality of photographing spot icons 210 displayed on a design drawing 200 by use of the operation part 24 and cause the display 23 to display an image 300 linked with the certain photographing spot icon 210.

Hereinafter, the description is made on an input of the annotation information 330 to the information terminal 20, for example. When the user inputs an operation of pushing an unillustrated edit button on the image 300 displayed on the display 23 by use of the operation part 24, a comment input field (not shown) appears in a left end or a right end of the design drawing 200. The user inputs an operation of specifying an annotation object with a frame (not shown) in the image 300 by use of the operation part 24. A portion defined by the frame is the annotated district 310. Further, the user inputs a comment related to the annotated district 310 in the comment input field by use of the operation part 24. The information terminal 20 sends as the annotation information 330 to the server 10 by use of a communication part 21, the information containing the annotated district 310 and comment information 320 representing the comment, which are inputted by use of the operation part 24. The annotation information 330 is linked with a photographing ID. An instruction receiving section 111 of the server 10 stores in the annotation information storage section 123 the annotation information 330 received by a communication part 13 in association with the photographing ID of the image 300. Accordingly, the annotation information 330 and the image 300 are linked with each other by the photographing ID as a key.

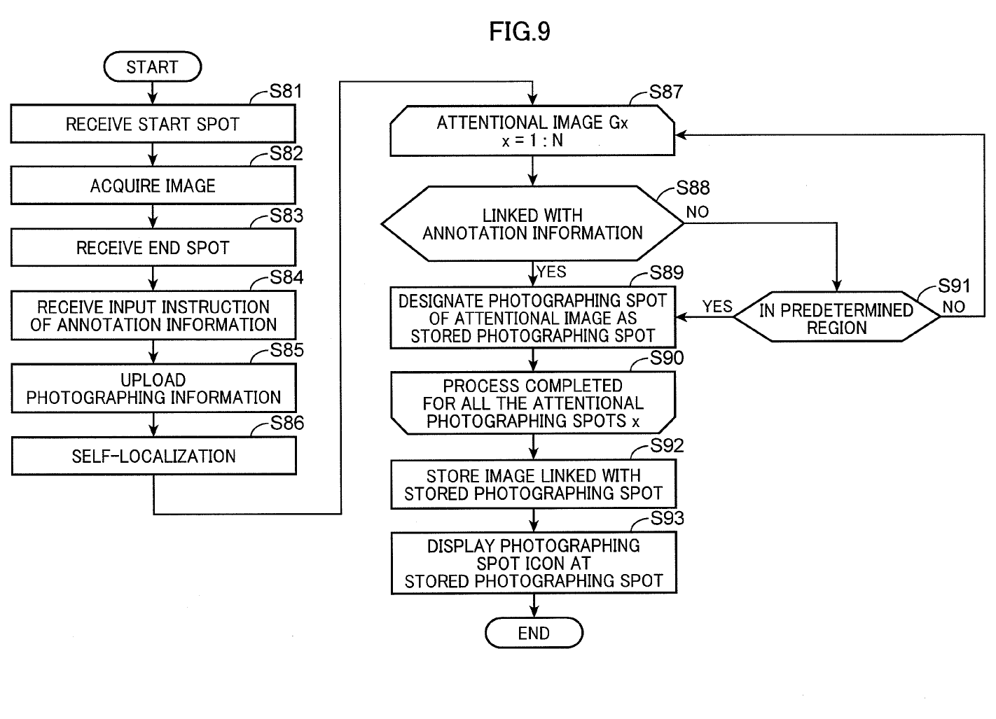

FIG. 9 is a flowchart showing a process of the information processing system 1A according to Embodiment 2. Processing in Steps S81 to S83 are identical to those in Steps S1 to S3 in FIG. 3.

In Step S84, the communication device 40 receives an input instruction of annotation information 330 from the photographing person. The photographing person may input the annotation information 330 to one or a plurality of images among images captured in a photographing period. The photographing person may input a plurality of pieces of annotation information 330 with respect to a single image.

Next, in Step S85, the communication device 40 acquires from the photographing device 30 photographing information including the images captured by the photographing device 30 in the photographing period, and uploads the acquired photographing information to the server 10. Further, the communication device 40 uploads the annotation information 330 inputted in Step S84 to the server 10.

Next, in Step S86, the display control section 112A applies the self-localization to each of the uploaded images to thereby calculate a photographing spot of each of the images in the same manner as in Step S5 in FIG. 3.

Next, in Step S87, the display control section 112A designates an attentional image Gx among the images uploaded in Step S85, and starts the processing on the designated attentional image Gx. Hereinafter, the description is made on a case where there are N (N being an integer of 2 or greater) images. The display control section 112A designates attentional images Gx according to an order of photographing times from the earliest. x is an index indicating each of the images, wherein x = 1 to N.

Next, in Step S88, the display control section 112A determines whether the attentional image Gx is linked with annotation information 330. The display control section 112 may execute this determination by judging whether the annotation information storage section 123 stores annotation information 330 linked with a photographing ID of the attentional image Gx.

When the attentional image Gx is linked with annotation information 330 (YES in Step S88), the flow proceeds to Step S89. When the attentional image Gx is linked with no annotation information 330 (NO in Step S88), the flow proceeds to Step S91.

Next, in Step S89, the photographing spot of the attentional image Gx is designated as a stored photographing spot.

Next, in Step S91, the display control section 112A determines whether the photographing spot of the attentional image Gx is in the predetermined region 230. When the photographing spot of the attentional image Gx is in the predetermined region 230 (YES in Step S91), the flow proceeds to Step S89. When the photographing spot of the attentional image Gx is in the outside region outside the predetermined region 230 (NO in Step S91), the flow returns to Step S87. In this case, a subsequent attentional image Gx is subjected to the processing of Step S88 onwards.

Next, in Step S90, it is determined whether the process is completed for all the attentional images Gx. When the process is not completed for all the attentional images Gx, the flow returns to Step S87, and a subsequent attentional image Gx is designated. On the other hand, when the process is completed for all the attentional images Gx, i.e., when the process for the attentional images Gx (= N) is completed, the flow proceeds to Step S92.

Processing in Steps S92 and S93 is identical to those in Steps S12 and S13 in FIG. 3.

As described above, in the information processing system 1A according to Embodiment 2, a larger quantity of photographing spot icons concerning spots around the photographing spot linked with the annotation information 330 can be displayed than the quantity of photographing spot icons concerning spots around the photographing spot linked with no annotation information. Consequently, the images captured at the photographing spots to which attention is called can be priorly stored.

Modification 1 of Embodiment 2

In Modification 1 of Embodiment 2, only photographing spot icons 210 linked with annotation information 330 are displayed.

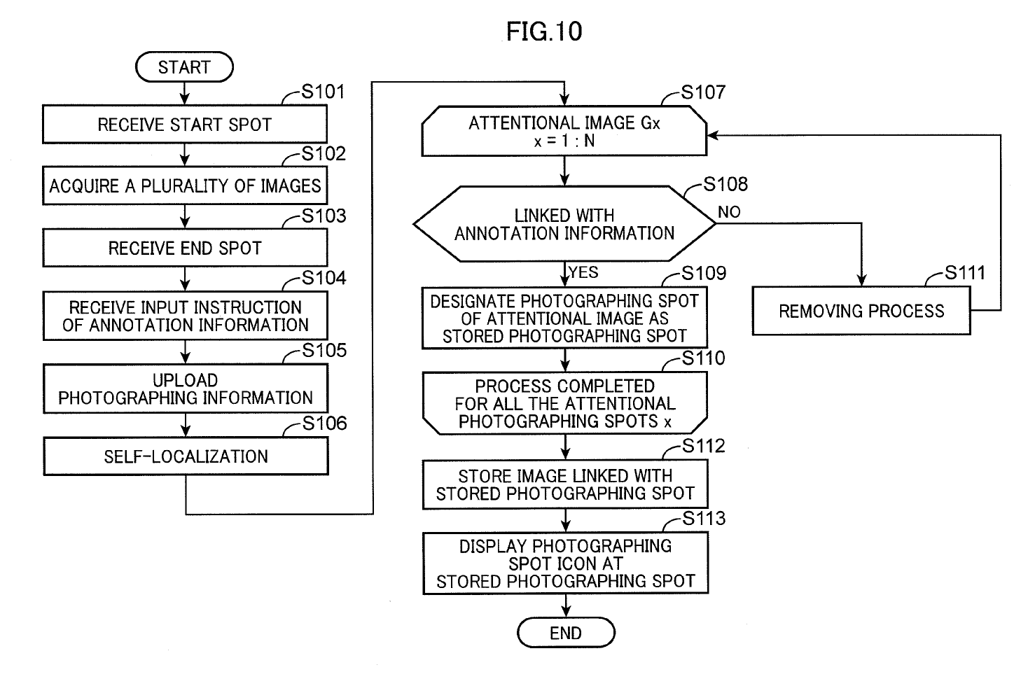

FIG. 10 is a flowchart showing a process of an information processing system 1A according to Modification 1 of Embodiment 2. Processing in Steps S101, S102, S103, S104, S105, S106, S107, S108, S109, S110, S112, and S113 is identical to those in Steps S81, S82, S83, S84, S85, S86, S87, S88, S89, S90, S92, and S93 in FIG. 9.

In Step S111, a display control section 112A executes a removing process. The removing process is a process of keeping a photographing spot of an attentional image Gx from being designated as a stored photographing spot.

As described above, in Modification 1 of Embodiment 2, only photographing spots of images linked with annotation information 330 are designated as a stored photographing spot. The display control section 112A displays only the photographing spot icons 210 indicating the stored photographing spots on a design drawing 200. The display control section 112A stores only the images captured at the stored photographing spots in an image information storage section 122.

This can prevent the annotation information and the image linked with the annotation information from being removed.

Modification 2 of Embodiment 2

The process described in Embodiment 1 may be used as the removing process described in Step S111. A display control section 112A does not remove but keeps a photographing spot icon 210 linked with annotation information 330 in an outside region (the first predetermined region) outside the predetermined region 230 among photographing spot icons 210 in the outside region. The display control section 112A does not remove but keeps a photographing spot icon 210 linked with annotation information 330 in the predetermined region (the second predetermined region) 230 among photographing spot icons 210 in the predetermined region 230.

More specifically, the display control section 112A may not remove but keep a photographing spot icon 210 in the outside region as long as the photographing spot icon 210 is linked with annotation information 330 even though the photographing spot icon 210 is a removal target among the photographing spot icons 210 in the outside region.

The photographing spot icon 210 being the removal target in the outside region is a photographing spot icon 210 linked with a photographing time that is not a time deduced by a first time interval. Alternatively, the photographing spot icon 210 being the removal target in the outside region is a photographing spot icon 210 indicating a photographing spot at a neighboring distance different from a first distance.

The display control section 112A may not remove but keep a photographing spot icon 210 in the predetermined region 230 as long as the photographing spot icon 210 is linked with annotation information 330 even though the photographing spot icon 210 is the removal target among the photographing spot icons 210 in the predetermined region 230.

The photographing spot icon 210 being the removal target in the predetermined region 230 is a photographing spot icon 210 linked with a photographing time that is not a time deduced by the second time interval. Alternatively, the photographing spot icon 210 being the removal target in the predetermined region 230 is a photographing spot icon 210 indicating a photographing spot at a neighboring distance different from the second distance.

Modification 3 of Embodiment 2

The process of designating a photographing spot linked with annotation information 330 as a stored photographing spot in Modification 2 of Embodiment 2 may be applied only to photographing spot icons 210 in the outside region outside the predetermined region 230.

Modification 4 of Embodiment 2

The display control section 112 may execute in real time during a photographing action a process described in Embodiment 2 and Modifications 1, 2 of Embodiment 2.

Embodiment 3

In Embodiment 3, a photographing spot icon 210 is extracted among a plurality of photographing spot icons 210 in such a manner that areas defined for the photographing spot icons 210 do not overlap one another. In Embodiment3, the same elements as those of Embodiments 1 and 2 are allotted with the same reference numerals. The description of the same elements is omitted.

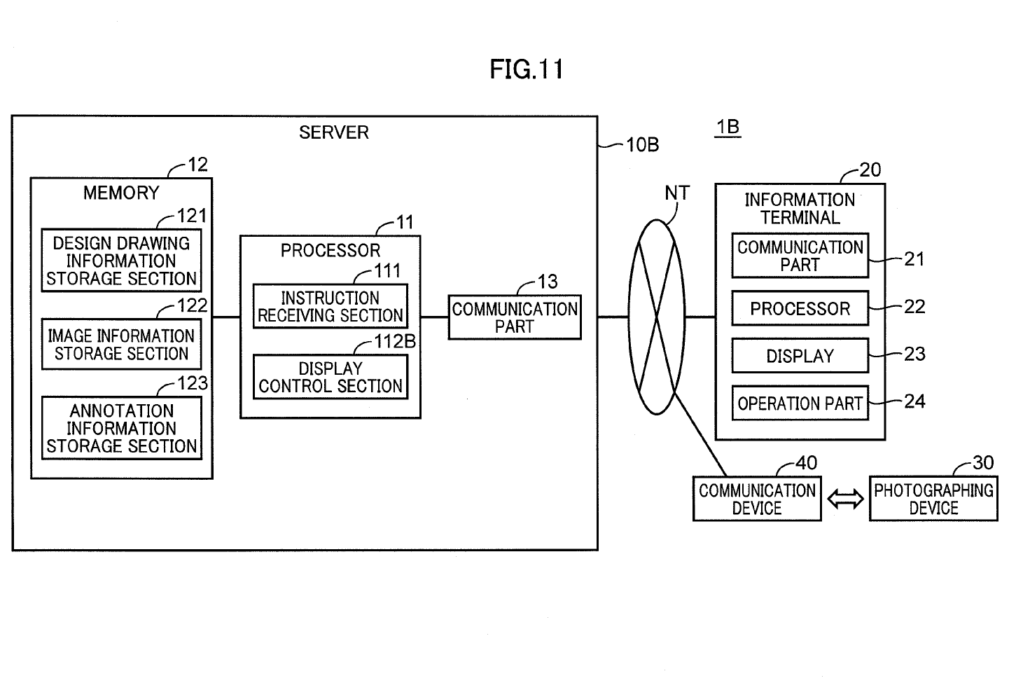

FIG. 11 is a diagram showing a general configuration of an information processing system 1B according to Embodiment 3. The information processing system 1B differs from the information processing system 1A in that the processor 11 includes a display control section 112B.

The display control section 112B defines an area surrounding a photographing spot for each of the photographing spot icons 210 on a design drawing 200.

The display control section 112B extracts a photographing spot icon 210 among the photographing spot icons 210 in such a manner that their areas do not overlap one other. The display control section 112B displays the extracted photographing spot icon 210. In Embodiment 3, a specified spot is a photographing spot indicated by the extracted photographing spot icon 210. In Embodiment 3, a first predetermined region is an area of the other photographing spot icon 210 than the extracted photographing spot icon 210.

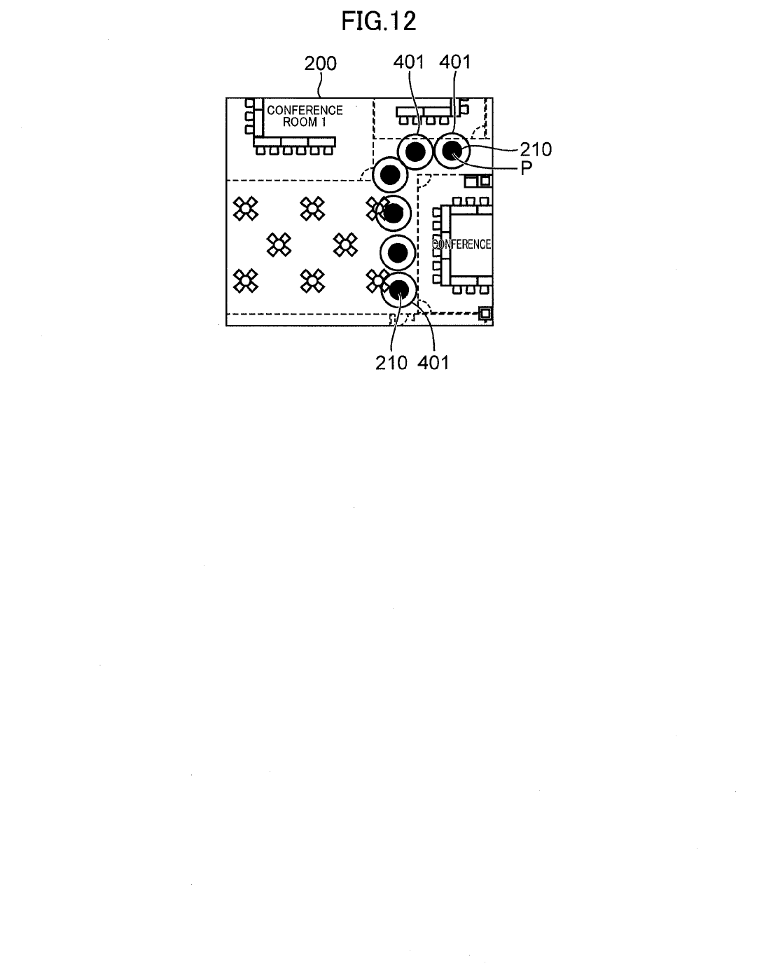

FIG. 12 shows a design drawing 200 resulting from a process in Embodiment 3. The photographing spot icon 210 is displayed in such a manner as to have a center at a photographing spot P. The display control section 112B defines an area 401 surrounding the photographing spot P for each of the photographing spot icons 210. The photographing spot icon 210 has a circular shape having a certain radius. The shape of the photographing spot icon 210 may be polygonal, e.g., triangular and quadrilateral. The area 401 has a circular shape having a radius greater than the radius of the photographing spot icon 210. However, this is merely an example. The area 401 may have a shape of a polygon having an area larger than an area of the photographing spot icon 210. Although FIG. 12 shows the area 401 for convenience of explanation, the area 401 is a non-display area.

The photographing spot icons 210 displayed on the design drawing 200 are the photographing spot icons 210 extracted by the display control section 112B. Therefore, there is no overlap between areas of any pair of photographing spot icons 210 displayed on the design drawing 200. This is because the display control section 112B extracts no photographing spot icon 210 with an overlapping area 401 as a display target.

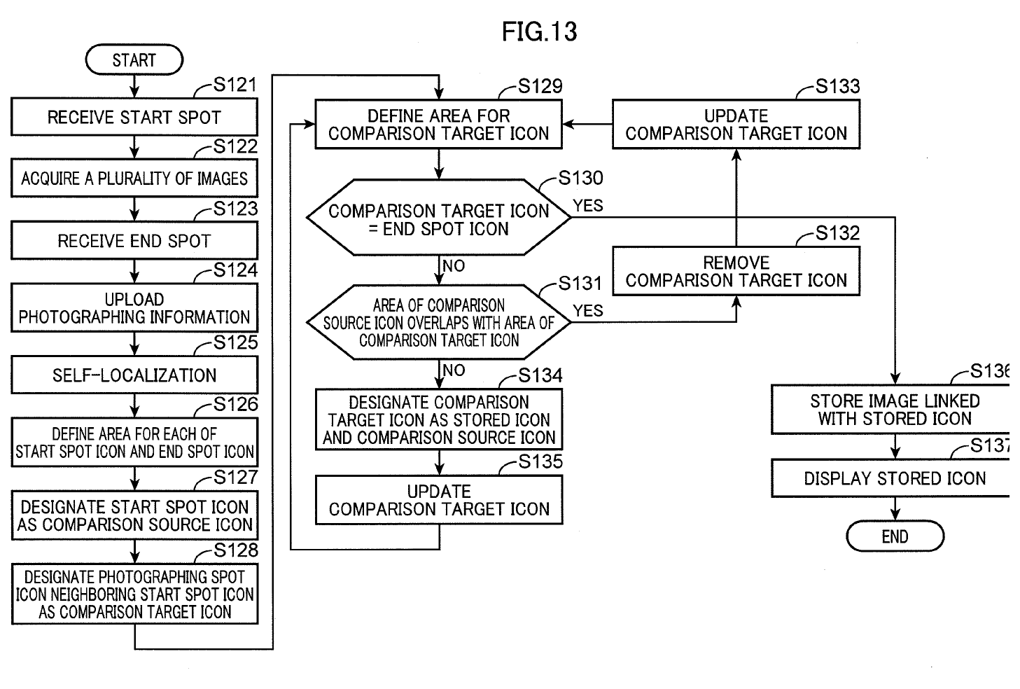

FIG. 13 is a flowchart showing the process of the information processing system 1B according to Embodiment 3. Processing in Steps S121, S122, S123, S124, and S125 are identical to those in Steps S1, S2, S3, S4, and S5 in FIG. 3.

In Step S126, the display control section 112B defines an area for each of a start spot icon and an end spot icon. The start spot icon is a photographing spot icon 210 linked with an image at the earliest photographing time among uploaded images. The end spot icon is a photographing spot icon 210 linked with an image at the latest photographing time among the uploaded images.

Next, in Step S127, the display control section 112B designates the start spot icon as a comparison source icon. The comparison source icon is a photographing spot icon 210 having been determined to be stored.

Next, in Step S128, the display control section 112B designates a photographing spot icon 210 neighboring the start spot icon as a comparison target icon. The photographing spot icon 210 neighboring the start spot icon is a photographing spot icon 210 linked with an image at the second earliest photographing time among the uploaded images.

Next, in Step S129, the display control section 112B defines an area 401 for the comparison target icon.

Next, in Step S130, the display control section 112B determines whether the comparison target icon is the end spot icon. When the comparison target icon is not the end spot icon (NO in Step S130), the flow proceeds to Step S131. When the comparison target icon is the end spot icon (YES in Step S130), the flow proceeds to Step S136.

Next, in Step S131, the display control section 112B determines whether the area 401 of the comparison source icon overlaps with the area 401 of the comparison target icon. When the area 401 of the comparison source icon overlaps with the area 401 of the comparison target icon (YES in Step S131), the display control section 112B removes the comparison target icon (Step S132).

Next, in Step S133, the display control section 112B updates a photographing spot icon 210 with the next earliest photographing time after the removed comparison target icon as the comparison target icon and the flow returns to Step S129. Accordingly, on the basis of the currently designated comparison source icon, the photographing spot icons 210 are sequentially designated as the comparison target icon in the order of the photographing times from the earliest.

On the other hand, when the area 401 of the comparison source icon does not overlap with the area 401 of the comparison target icon (NO in Step S131), the display control section 112B designates the comparison target icon as the stored icon, and designates the comparison target icon as the comparison source icon (Step S134). In this manner, a comparison target icon with an area 401 not overlapping with the currently designated comparison source icon is stored and designated as the new comparison source icon.

Next, in Step S135, the display control section 112B updates the comparison target icon (Step S135), and the flow returns to Step S129. Accordingly, on the basis of the updated comparison source icon, the photographing spot icons 210 are sequentially designated as the comparison target icon in the order of the photographing times from the earliest.

Next, in Step S136, the display control section 112B stores an image linked with the stored icon in an image information storage section 122. Here, the end spot icon is designated as a stored icon. This is because it is reasonable to keep the end spot icon indicating the end spot inputted by a user. The end spot icon is designated as the stored icon even when the area 401 of the end spot icon overlaps with an area 401 of a neighboring stored icon.

Next, in Step S137, the display control section 112B displays the stored icons on the design drawing 200. Thus, the design drawing 200 shown in FIG. 12 is obtained.

As described above, in the information processing system 1B according to Embodiment 3, the photographing spot icons 210 are extracted in such a manner that their areas 401 do not overlap one another. Therefore, the photographing spot icons can be efficiently thinned out.

Non-display of a start spot icon and an end spot icon can be seen to give a sense of inadequacy to the user who had inputted the start spot and the end spot. In this configuration, the start spot icon and the end spot icon are always maintained. This can avoid giving the sense of inadequacy to the user.

The present disclosure is useful in remotely monitoring a site.

1. An information processing method, by a computer, comprising: displaying a bird’s-eye view including a specified spot on a display of an information terminal; and displaying in the bird’s-eye view a plurality of photographing spot icons each indicating a photographing spot and being linked with an image captured at the photographing spot, wherein the displaying includes reducing the display quantity of photographing spot icons in a first predetermined region including no specified spot.

2. The information processing method according to claim 1, wherein the specified spot is at a coordinate preset in the bird’s-eye view, and the reducing of the display quantity includes reducing the display quantity of photographing spot icons in the first predetermined region so as to be smaller than the display quantity of photographing spot icons in a second predetermined region including the specified spot.

3. The information processing method according to claim 1,wherein the specified spot is a photographing spot indicated by a photographing spot icon linked with annotation information.

4. The information processing method according to claim 1, wherein each of the photographing spot icons has an area surrounding the photographing spot in the bird’s-eye view, the displaying includes extracting a photographing spot icon among the photographing spot icons in such a manner that their areas do not overlap one another, and displaying the extracted photographing spot icon, the specified spot is the photographing spot indicated by the extracted photographing spot icon, and the first predetermined region is the area of the other photographing spot icon than the extracted photographing spot icon.

5. The information processing method according to claim 2, wherein the reducing of the display quantity includes keeping a photographing spot icon linked with annotation information in the first predetermined region among the photographing spot icons in the first predetermined region.

6. The information processing method according to claim 1, wherein the display quantity of photographing spot icons in the first predetermined region is set to a value of keeping a resolution preset for the photographing spots.

7. The information processing method according to claim 2, wherein the display quantity of photographing spot icons in the second predetermined region is set to a value that accords with a frame rate for the photographing.

8. The information processing method according to claim 2, wherein the bird’s-eye view includes a bird’s-eye view of a building including a column, a wall, or a material, and the display quantity of photographing spot icons in the second predetermined region is set to such a value that one photographic spot indicated by one photographing spot icon is at one side of the column, the wall, or the material, and another photographic spot indicated by another photographing spot icon is at another side of the column, the wall, or the material.

9. The information processing method according to claim 2, wherein each of the photographing spot icons is linked with a photographing time of the linked image, and the reducing of the display quantity includes displaying photographing spot icons in the first predetermined region in such a display quantity that a time interval between a photographing time linked with a photographing spot icon and a photographing time linked with its neighboring photographing spot icon is a first time interval; and displaying photographing spot icons in the second predetermined region in such a display quantity that a time interval between a photographing time linked with a photographing spot icon and a photographing time linked with its neighboring photographing spot icon is a second time interval shorter than the first time interval.

10. The information processing method according to claim 2, wherein the reducing of the display quantity includes displaying photographing spot icons in the first predetermined region in such a manner that a distance between neighboring photographing spot icons becomes a first distance, and displaying photographing spot icons in the second predetermined region in such a manner that a distance between neighboring photographing spot icons becomes a second distance shorter than the first distance.

11. An information processing apparatus, comprising a processor that causes: displaying a bird’s-eye view including a specified spot on a display of an information terminal, and displaying in the bird’s-eye view a plurality of photographing spot icons each indicating a photographing spot and being linked with an image captured at the photographing spot, wherein the displaying includes reducing the display quantity of photographing spot icons in a first predetermined region including no specified spot.

12. A non-transitory computer readable recording medium storing an information processing program causing a computer to: display a bird’s-eye view including a specified spot on a display of an information terminal; and display in the bird’s-eye view a plurality of photographing spot icons each indicating a photographing spot and being linked with an image captured at the photographing spot, wherein the displaying includes reducing the display quantity of photographing spot icons in a first predetermined region including no specified spot.
